(19) United States
(12) Patent Application Publication
(10) Pub. No.: US 2003/0209073 A1
(43) Pub. Date: Nov. 13, 2003

(54) Tuned flexure accelerometer

(76) Inventors: Raymond Carroll, Boxford, MA (US); Charles R. Dauwalter, Newton Highlands, MA (US); Donato Cardarelli, Medfield, MA (US)

Correspondence Address: Brian M. Dingman, Esq., Mirick, O'Connell, DeMallie & Lougee, LLP, 1700 West Park Drive, Westborough, MA, 01581-3941, US

(21) Appl. No.: 10/417,857

(22) Filed: Apr. 17, 2003

Related U.S. Application Data
(60) Provisional application No. 60/373,267, filed on Apr. 17, 2002.

(51) Int. Cl. G01P 15/13

(52) U.S. Cl. 73/504.09; 73/514.21

(57) ABSTRACT

This invention relates to additional embodiments of the tuned flexure accelerometer (TFA) concept. The TFA reduces or eliminates the elastic restraint (also termed “spring stiffness”) of the reference mass support by means of oscillation to improve the ability to accurately measure distance, velocity or acceleration with the accelerometer. The invention also relates to tuning flexures in other applications such as mirrors so as to allow the mirror to hold rotation or translation position once moved, without additional torque or force.

### CROSS REFERENCE TO RELATED APPLICATION

This application claims priority of Provisional Application serial No. 60/373,267, filed on Apr. 17, 2002.

### STATEMENT OF FEDERALLY SPONSORED RESEARCH AND DEVELOPMENT

This invention was made with Government support under contract number DASG60-01-C-0004 awarded by U.S. Army Space and Missile Defense sponsored by the Missile Defense Agency. The Government has certain rights in the invention.

### FIELD OF THE INVENTION

This invention relates to additional embodiments of the tuned flexure accelerometer (TFA) concept. The TFA reduces or eliminates the elastic restraint (also termed “spring stiffness”) of the reference mass support by means of oscillation, to improve the ability to accurately measure distance, velocity or acceleration with the accelerometer.

### BACKGROUND OF THE INVENTION

Accelerometers use a reference mass that is somehow supported within a housing that is attached to the body whose motion is to be measured. With acceleration of the body, the housing moves relative to the reference mass. Relative to the housing, the motion of the reference mass is measured with a pick-off. For open loop accelerometers, the pick-off signal is proportional to acceleration and can be calibrated using known input accelerations. For closed loop accelerometers, the pick-off signal is fed to a control loop whose output drives an actuator which is used to force the reference mass back to a reference position. The actuator input is then proportional to the acceleration and can be calibrated with known input accelerations.

The tuned flexure accelerometer (TFA) is a subset of flexured accelerometers in general; many TFA embodiments can readily be fabricated with MEMS (MicroElectroMechanical Systems) technology. A limit to the performance of all flexure supported reference mass accelerometers is bias instability due to the finite flexure elastic restraint (or spring stiffness) and pick-off instability. The Tuned Flexure Accelerometer described in U.S. Pat. No. 6,338,274 B1 reduces this error through dynamic means to develop a net flexure stiffness that can be reduced or even adjusted to zero without compromising flexure strength.

There are two general types of accelerometers, linear and pendulous. This invention is applicable to both types for which flexures provide restraint of the reference mass or pendulum. In the linear type, the reference mass moves translationally relative to the housing. In the pendulous type, the reference mass may be attached to a member (often termed the “moment arm”) and the combination supported and constrained to rotate about an axis of rotation defined by flexures.

Additionally, by dynamically tuning the effective stiffness of the flexures to zero, the condition of a “free mass” may be achieved. Closed loop operation is necessary in this case and a force or torque actuator is used to balance the acceleration-produced force or torque. With the addition of damping of the reference mass motion, the instrument can accurately measure velocity change directly. In the case of momentary power outage, the pendulum stores the velocity change with deflection. The velocity is subsequently recovered with loop closure.

This invention addresses a problem in the prior art, that soft (i.e., very flexible) flexures are needed to increase the sensitivity of the accelerometer, while stiff (i.e., very inflexible) flexures are required to provide ruggedness and to constrain the other five degrees of freedom, to prevent motions that may degrade the performance or survivability of the accelerometer. These conflicting requirements cannot both be satisfied simultaneously. This is a perennial limitation of accelerometers utilizing flexure suspended reference masses. Previous approaches for addressing this problem have been to:

1) float the pendulous mass in a neutrally buoyant viscous fluid (eliminating the flexures), which is expensive;

2) decrease the reference mass to reduce the responses in the other 5 degrees of freedom; however, this reduces accelerometer sensitivity and degrades the signal-to-noise ratio;

3) utilize actuators having higher force or torque capability to provide wider dynamic range; this can require more power and may result in larger instruments;

4) provide smaller gaps to increase the damping constant; this makes the instrument more rugged and can improve read-out bias stability; however the bias instability is still dominated by the flexure forces/torques; and to

5) improve the read-out stability and reduce error torques by improvements in technology and careful design and assembly.

These approaches have been taken to their limits over the last several decades.

### SUMMARY OF THE INVENTION

In accelerometer technology, it is known that eliminating the elastic restraint from the single degree of freedom reference mass support can greatly improve the ability to accurately measure acceleration and velocity. This invention provides a means to reduce, or completely eliminate, the elastic restraint of the flexurally-supported reference mass or pendulum by the application of a dynamic tuning method.

This invention describes additional embodiments of the TFA. In addition to embodiments utilizing pendulous reference masses, embodiments in which the reference mass is constrained to linear motion are also described. Damping is also introduced to form a tuned flexure integrating accelerometer for which the output is proportional to velocity. This invention may also be usefully extended to devices other than accelerometers (e.g., mirrors) which utilize flexure-supported members.

The additional embodiments cover conceptual approaches not covered in the original TFA U.S. Pat. No. 6,338,274 B1. The additional embodiments also relate to use of the tuned flexure invention to tune flexures in other applications such as mirrors so as to allow the mirror to hold rotation angle or translation position once moved, without additional torque or force.

A typical planar single degree of freedom (SDF) closed loop, flexure-restrained, pendulous accelerometer 19 with damping of the reference mass motion is shown in FIG. 1.

The reference mass 10 is mounted on a moment arm 15 which is attached to the base (case, housing) 70 by flexures 20,30. The flexures constrain the motion of the combined reference mass 10 and moment arm 15, said combination being referred to herein as the “pendulum”. The pendulum rotates about the y-axis 110. Under acceleration a_{z} along the z-axis 120 the pendulum tends to rotate about the y-axis 110 away from its reference position. The rotation of the pendulum 10, 15 is opposed by physical damping having damping constant D_{T}. The resulting rotation angle, θ, of the pendulum is sensed by the pickoff 200. The pick-off signal is suitably amplified by control loop amplifier 600 and fed back to an actuator 300 to produce a torque acting on the pendulum 10,15 to return it to the reference position.

The equation of motion for a pendulum is given by

I_{To}\ddot{θ}+D_{T}\dot{θ}+K_{T}θ=Pa−Γ_{L} (1)

where

θpendulum rotation angle

I_{To} moment of inertia of the pendulum about the y-axis

D_{T} damping constant

K_{T} spring constant of the supporting flexures

P=mRₘ pendulosity (product of the reference mass m and its distance Rₘ from the pendulum axis of rotation),

Γ_{L} the rebalance torque provided by the actuator driven by the control loop,

a the acceleration along the Input Axis.

A similar equation of motion is developed for the linear mass accelerometer where the rotation angle is replaced by a translation. In the steady-state, for the spring dominant case, the equation may be simplified to

K_{T}θ=Pa−Γ_{L} (2)

When operated open loop, the relationship between the pendulum rotation angle and acceleration is

$$ϑ = \frac{P}{{K}_{T}} a \qquad ( 3 )$$

where the quantity

$$\frac{P}{{K}_{T}}$$

is often referred to as the “Scale Factor” or sensitivity.

To increase the accelerometer sensitivity, either the pendulosity, P, can be increased, the flexure stiffness, K_{T}, decreased, or both can be done. The pendulum rotation angle, θ, is measured by the pick-off. A variable capacitance type pick-off may be utilized, which may be implemented by interleaved finger-like combs or by opposing flat metallic areas. Such pick-offs are often implemented in the differential mode, in which one of two capacitances increases with increasing angle and the other decreases. The total signal is obtained by subtracting the two capacitance changes. Differential operation allows for the cancellation of common-mode errors.

The pick-off bias instability (defined as the non-zero capacitance or differential capacitance signal when the mass is at the reference position) can be related to the angle measurement instability and by equation (3) to a perceived acceleration or acceleration bias error, δa, given in terms of the pick-off instability, δθ.

$$δ a = \frac{{K}_{T}}{P} δ ϑ \qquad ( 4 )$$

To improve the bias stability of the measured acceleration (i.e., to reduce δa) requires that the pick-off instability is reduced, the pendulosity increased or the spring constant decreased. With dynamic tuning, the stiffness is reduced.

The closed loop pendulous tuned flexure accelerometer (TFA) is shown in FIG. 2. It is identical to the typical accelerometer shown in FIG. 1, but with the addition of a gimbal 60 supported by flexures 80,90, to which the pendulum 10, 15 is attached (compare this with FIG. 1). The gimbal 60 and with it the pendulum 10, 15, is oscillated by actuator 400, to develop a negative elastic restraint on the pendulum 10,15. Under acceleration a_{z} along the z-axis 120, the pendulum tends to rotate about the y-axis 110 away from its reference position. The rotation of the pendulum 10, 15 is opposed by physical damping having damping constant D_{T}. The resulting rotation angle, θ, of the pendulum is sensed by the pickoff 200, the pickoff signal suitably amplified by control loop amplifier 600 and fed back to an actuator 300 which produces a torque acting on the pendulum 10,15 to return it to the reference position. The pendulum equation of motion for rotation about the y-axis 110 (Output Axis) for the tuned case is

I_{To}\ddot{θ}+D_{T}\dot{θ}+(K_{T}−K_{D})θ=Pa−Γ_{L} (5)

where the stiffness, K_{T}, is replaced by the effective stiffness (K_{T}−K_{D}) and K_{D} is the negative elastic restraint. The negative elastic restraint is developed by the sinusoidal oscillation of the gimbal and is given by

K_{D}=−\dot{φ}²ΔI=−½ΔI_{T}ω²\tilde{φ}² (6)

where

φ=\tilde{φ}sinωt is the gimbal oscillation amplitude,

\tilde{φ} is the peak amplitude of oscillation,

ω is the circular frequency of oscillation,

ΔI_{T}=I_{y}−Iₓ is the tuning inertia and is negative for tuning to occur, and

I_{y},Iₓ are the pendulum moments of inertia about the y-axis and x-axis respectively.

For a dynamically tuned accelerometer that is not perfectly tuned and operated open loop, the reference mass deflection angle is related to acceleration by

$$a = \frac{( {K}_{T} - {K}_{D} )}{P} ϑ \qquad ( 7 )$$

where the scale factor,

$$\frac{( {K}_{T} - {K}_{D} )}{P} ,$$

is not uniquely determined by the reference mass flexure support stiffness, K_{T}, but can be altered by tuning (varying K_{D}). This means that the accelerometer scale factor can be altered (varied) during operation by changing the tuning amplitude and/or frequency. An application example is to operate the accelerometer with a stiff flexure during a period of high acceleration (such as a gun launch) and tune it to a highly sensitive, softer mode afterwards. This describes a variable scale factor implementation.

For a dynamically tuned accelerometer that is not perfectly tuned and operated open loop, the acceleration instability, δa, is related to the pickoff instability, δθ, by

$$δ a = \frac{( {K}_{T} - {K}_{D} )}{P} δ ϑ \qquad ( 8 )$$

Equation 8 shows that the acceleration measurement instability, δa, can be reduced by dynamic tuning without physically altering the flexure itself and, thus, without affecting the ruggedness of the accelerometer. If the effective elastic restraint, (K_{T}−K_{D}), is reduced to zero by properly adjusting the oscillation amplitude and/or frequency, the acceleration instability, δa, caused by the pickoff instability, δθ, is entirely eliminated.

Damping Dominant Case

For a perfectly tuned TFA with damping D_{T} (damping dominant case), and operating in the open loop mode, the equation of motion is reduced to the damping term on the left side of the equation and the re-balance torque removed. By integrating both sides, the measured change in velocity between times t₁ and t₂ may be expressed as

$${\int }_{{t}_{1}}^{{t}_{2}} \dot{ϑ} ⅆ t = \frac{P}{{D}_{T}} {\int }_{{t}_{1}}^{{t}_{2}} a ⅆ t \qquad ( 9 )$$

therefore

$$( {ϑ}_{2} - {ϑ}_{1} ) = \frac{P}{{D}_{T}} ( {v}_{2} - {v}_{1} ) \qquad ( 10 )$$

In other words,

$$Δ v = \frac{{D}_{T}}{P} Δ ϑ \qquad ( 11 )$$

That is, the rotation of the pendulum, Δθ, over a time interval is a measure of the change in velocity, Δv, occurring over that interval. This is of substantial importance in vehicle navigation systems because it means that, in the event of a momentary power interruption during a mission, the correct velocity change information is measured during the outage and is not lost. However, this can only be true if the effective elastic restraint is identically zero, otherwise, the flexure would gradually return the pendulum to the reference position even though the velocity had not changed at all.

The key is damping dominance and this dominance can be obtained for a lower damping constant if the spring constant is less. With reduced damping another error in accelerometers (in this case integrating accelerometer or velocimeter) that is due to Brownian motion noise is reduced because of mechanical integration that occurs in the damped accelerometer. Otherwise, in accelerometers for which the acceleration is numerically integrated, the Brownian noise contributes velocity random walk. Furthermore, the spring-mass of the accelerometer will often have a resonant frequency within, or near to, the desired measurement bandwidth. Damping is useful to reduce the amplitude of the resonant response in this case. Usually an accelerometer is designed to operate highly damped. Damping also minimizes the response to shock and vibration (both within as well as beyond the measurement bandwidth) without unnecessarily reducing the sensitivity to acceleration. Dynamic tuning of this invention can reduce the resonant frequency to zero, eliminating the resonant response entirely. This also provides an extremely long time constant; for perfect tuning, the time constant is effectively infinite. These are characteristics that could otherwise only be obtained with fluid-filled instruments in the prior art.

Because one may wish to dampen the motion of the reference mass or pendulum while operating the drive with low losses, a design will need to include separate chambers for the reference mass or pendulum and the driven gimbal (element 60 in FIG. 2). In this way the medium in each can be set separately.

Open Loop and Closed Loop Operations

Unless effective stiffness for the reference mass or pendulum is totally removed, the accelerometers can be operated in open loop as well as closed loop mode.

Variable Scale Factor Operation

For each tuned flexure accelerometer, the effective stiffness can be changed by changing the frequency or amplitude of gimbal oscillation. The change can also be made during the course of an application to optimize the signal according to the level of acceleration. This is similar to auto scaling.

Non-Planar Designs

The use of dynamic tuning equally applies to designs that are not considered planar.

### BRIEF DESCRIPTION OF THE DRAWINGS

Other objects, features and advantages will occur to those skilled in the art from the following description of the preferred embodiments, and the accompanying drawings:

FIG. 1 is a rendition of a typical planar pendulous closed loop accelerometer, that can be implemented in MEMS, capable of sensing acceleration input along the z-axis (normal to the plane).

FIG. 2 depicts an embodiment of a planar, tuned flexure pendulous closed loop accelerometer capable of sensing acceleration input along the z-axis (normal to the plane).

The following figures depict open loop accelerometer embodiments, but one skilled in the art will understand that each of the accelerometer concepts depicted could alternatively be operated in the closed loop mode and realize the benefits conferred by closed loop operation.

FIG. 3 depicts an embodiment of a planar, tuned flexure pendulous accelerometer capable of sensing acceleration input along the z-axis.

FIG. 4 depicts an embodiment of a planar, tuned flexure pendulous accelerometer capable of sensing acceleration input along the x-axis (along an axis in the plane).

FIG. 5 depicts an embodiment of a planar, tuned flexure pendulous accelerometer capable of sensing acceleration input along the x-axis (along an axis in the plane).

FIG. 6 depicts an embodiment of a planar, tuned flexure linear accelerometer capable of sensing acceleration input along the z-axis.

FIG. 7 depicts an embodiment of a planar, tuned flexure linear accelerometer capable of sensing acceleration input along the z-axis.

FIG. 8 depicts an embodiment of a planar, tuned flexure linear accelerometer capable of sensing acceleration input along the y-axis.

FIG. 9 depicts an embodiment of a planar, tuned flexure linear accelerometer capable of sensing acceleration input along the y-axis.

FIG. 10 depicts an embodiment of a planar, tuned-flexure linear accelerometer capable of sensing acceleration input along the y-axis with a gimbal that is oscillated in the plane; the reference mass is the inner member.

FIG. 11 depicts an embodiment of a planar, tuned-flexure linear accelerometer capable of sensing acceleration input along the y-axis with a gimbal that is oscillated in the plane; the reference mass is the outer member.

FIG. 12 depicts an embodiment of a planar, two degree of freedom, tuned flexure pendulous accelerometer capable of sensing acceleration inputs along the y-axis and along the z-axis (normal to the plane and in the plane).

FIG. 13 describes an embodiment of a planar, two degree of freedom, tuned flexure pendulum accelerometer that is capable of sensing acceleration inputs along the y-axis and along the z-axis (normal to the plane and in the plane).

FIG. 14 describes an embodiment of a planar, two degree of freedom, tuned flexure linear accelerometer capable of sensing acceleration inputs along the y-axis and along the z-axis.

FIG. 15 describes an embodiment of a planar, two degree of freedom, tuned flexure linear accelerometer capable of sensing acceleration inputs along the y-axis and along the z-axis.

FIG. 16 depicts an embodiment of a multi-layer pendulum, tuned flexure linear accelerometer to accomplish separate chambers for the pendulum 10,15 (see FIG. 2 for example) and for the driven gimbal.

### DESCRIPTION OF THE PREFERRED EMBODIMENTS

This invention may be realized in a tuned flexure pendulous accelerometer comprising: a housing (case); a gimbal coupled to the housing that oscillates about a gimbal oscillation axis; a reference mass/pendulum coupled by one or more flexures to the gimbal to allow rotation of the reference mass relative to the gimbal about an axis which is transverse to the gimbal oscillation axis and is not coincident with the center of mass of the reference mass (e.g., is pendulous), the one or more flexures having an effective elastic restraint; and means for inducing on the reference mass an oscillating negative elastic restraint having a non-zero time averaged value, to reduce the effective elastic restraint of the flexures.

The invention may also be realized in a tuned flexure accelerometer comprising a housing (case), a gimbal coupled to the housing that oscillates about a gimbal oscillation axis; a reference mass coupled by one or more flexures to the gimbal to allow linear motion of the reference mass relative to the gimbal along an axis which is transverse to the gimbal oscillation axis.

In both cases, the pendulum or reference mass can be the inside or outside member with the case (housing) as the outside or inside member respectively. The gimbal is the middle member that connects the other two. There are two advantages to embodiments with the pendulum or reference mass as the outer member. The first regards the attachment of the device to a substrate. The attachment is made through the case (inner member) that is smaller. Because it is smaller it does not generate as much stress due to thermal expansion mismatch between the device and the substrate. The second advantage is that the pendulum or reference mass is the outer member and is therefore larger and provides a longer moment arm for the pendulum and larger reference mass contributing to greater pendulosity and hence greater acceleration sensitivity.

In all embodiments for which sensitivity is described about the x-axis or along the y-axis, it is understood that the x-axis and y-axis are in the plane and the designations are interchangeable.

Pendulum TFA Embodiments

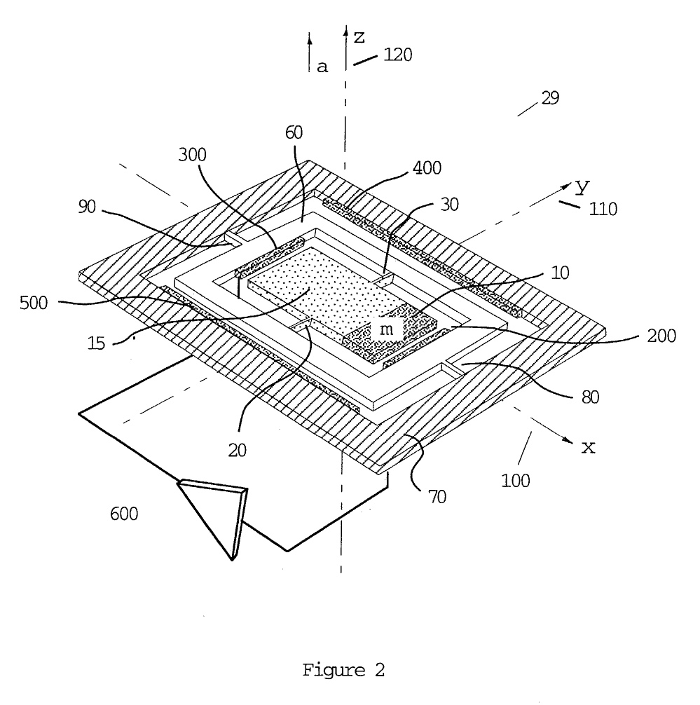

FIG. 2 depicts an embodiment of a planar, tuned flexure, pendulous, closed loop accelerometer 29 capable of sensing acceleration input along the z-axis 120; the reference mass 10 is on the inner member (moment arm) 15 to form the pendulum. The pendulum 10,15 is supported on and attached to the gimbal 60 by two flexures 20, 30 which terminate on the gimbal. The pendulum is the inner member. The gimbal is mounted to the base (case, housing) 70 by means of two flexures 80, 90. The gimbal, and with it the pendulum is caused to oscillate about the x-axis 100 by an actuator 400. The oscillatory motion of the gimbal is measured with pick-off 500. The said oscillatory motion induces on the pendulum a negative elastic restraint for rotations of the pendulum about the y-axis 110 that adds (algebraically) to the positive elastic restraint of the pendulum flexures 20, 30 for rotations of the pendulum about the y-axis 110. Consequently, the net elastic restraint of the pendulum for rotations about the y-axis 110 is smaller than the elastic restraint of the flexures 20, 30 for those motions. Under acceleration a_{z} along the z-axis 120, the pendulum tends to rotate about the y-axis 110 away from its reference position. The resulting rotation angle, θ, of the pendulum is sensed by the pick-off 200, the pick-off signal is suitably amplified by control loop amplifier 600 and fed back to an actuator 300 which produces a torque acting on the pendulum to return it to the reference position. If desired, the net elastic restraint of the pendulum for rotations of the pendulum about the y-axis 110 can be made identically zero by appropriately choosing the frequency and amplitude of the oscillation of the gimbal 60.

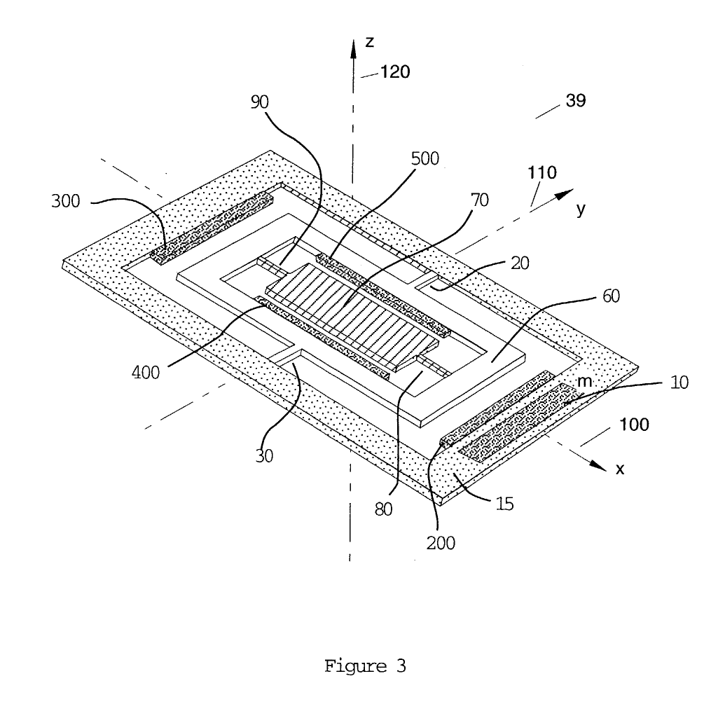

FIG. 3 depicts an embodiment of a planar, tuned flexure, pendulous accelerometer 39 capable of sensing acceleration input along the z-axis 120; the reference mass 10 is on the outer member 15 (moment arm in this case) forming a pendulum. The outer member 15 is attached to the gimbal 60 by two flexures 20, 30 which terminate on the gimbal. The gimbal is mounted to the base 70 by means of two flexures 80, 90. The gimbal, and with it the pendulum, comprised of the reference mass 10 and outer member 15, is caused to oscillate about the x-axis 100 by an actuator 400. The motion of the gimbal is measured by pick-off 500. The said oscillatory motion induces on the pendulum a negative elastic restraint for rotation of the pendulum about the y-axis 110 that adds (algebraically) to the positive elastic restraint of the pendulum flexures 20, 30 for rotation of the pendulum about the y-axis 110. Consequently, the net elastic restraint of the pendulum for rotations about the y-axis 110 is smaller than the elastic restraint of the flexures 20, 30 for those rotations. Under acceleration a_{z} along the z-axis 120 the pendulum tends to rotate about the y-axis 110 away from its reference position. The resulting rotation angle, θ, of the pendulum is sensed by the pick-off 200, the pick-off signal is suitably amplified by control loop amplifier (not shown) and fed back to an actuator 300 which produces a torque acting on the pendulum 10,15 to return it to the reference position. If desired, the net elastic restraint of the pendulum for rotations of the pendulum about the y-axis 110 can be made identically zero by appropriately choosing the frequency and amplitude of the oscillation of the gimbal 60.

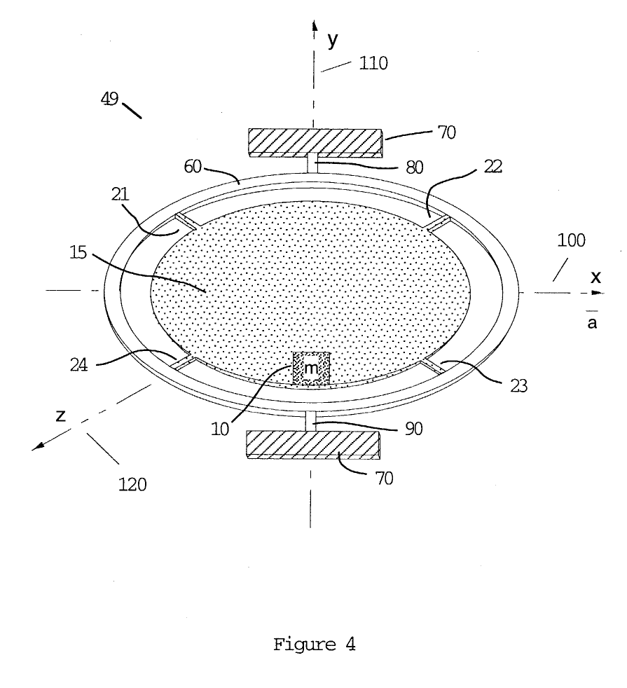

FIG. 4 depicts an embodiment of a planar, tuned flexure, pendulous accelerometer 49 capable of sensing acceleration input along the x-axis 100; the reference mass 10 is on the moment arm (inner member) 15 forming a pendulum. The pendulum is attached to the gimbal 60 by radial flexures 21, 22, 23, 24 which terminate on the gimbal 60. The gimbal 60 is mounted to the base (case) 70 by means of two flexures 80, 90. The gimbal, and with it the pendulum, comprised of the reference mass 10 and inner member 15, is caused to oscillate about the y-axis 110 by an actuator (not shown). The said oscillatory motion induces on the pendulum a negative elastic restraint for rotations of the pendulum about the z-axis 120 that adds (algebraically) to the positive elastic restraint of the pendulum flexures 21, 22, 23, 24 for rotations of the reference mass about the z-axis 120. Consequently, the net elastic restraint of the pendulum for rotations about the z-axis 120 is smaller than the elastic restraint of the flexures 21, 22, 23, 24 for those rotations. Under acceleration aₓ along the x-axis 100 the pendulum tends to rotate about the z-axis 120 away from its reference position. The resulting rotation angle, θ, of the pendulum is sensed by a pick-off (not shown), the pick-off signal is suitably amplified by control loop amplifier (not shown) and fed back to an actuator (not shown) which produces a torque acting on the pendulum 10,15 to return it to the reference position. If desired, the net elastic restraint of the pendulum for rotation of the pendulum about the z-axis 120 can be made identically zero by appropriately choosing the frequency and amplitude of the oscillation of the gimbal 60.

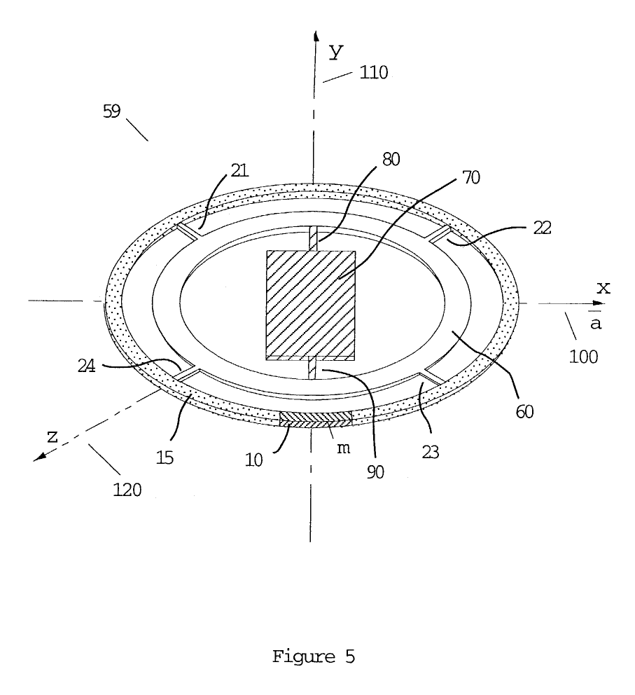

FIG. 5 depicts an embodiment of a planar, tuned flexure, pendulous accelerometer 59 capable of sensing acceleration input along the x-axis 100; the reference mass 10 is on the pendulum (outer) member 15 forming a pendulum. The pendulum is attached to the gimbal 60 by radial flexures 21, 22, 23, 24 which terminate on the gimbal 60. The gimbal 60 is mounted to the base (case) 70 by means of two flexures 80, 90. The gimbal 60, and with it the pendulum, comprised of the reference mass 10 and inner member 15, is caused to oscillate about the y-axis 110 by an actuator (not shown). The said oscillatory motion induces on the pendulum a negative elastic restraint for rotations of the pendulum about the z-axis 120 that adds (algebraically) to the positive elastic restraint of the pendulum flexures 21, 22, 23, 24 for rotations of the reference mass about the z-axis 120. Consequently, the net elastic restraint of the pendulum for rotations about the z-axis 120 is smaller than the elastic restraint of the flexures 21, 22, 23, 24 for those rotations. Under acceleration aₓ along the x-axis 100 the pendulum tends to rotate about the z-axis 120 away from its reference position. The resulting rotation angle, θ, of the pendulum is sensed by a pick-off (not shown), the pick-off signal is suitably amplified by control loop amplifier (not shown) and fed back to an actuator (not shown) which produces a torque acting on the pendulum 10,15 to return it to the reference position. If desired, the net elastic restraint of the pendulum for rotation of the pendulum about the z-axis 120 can be made identically zero by appropriately choosing the frequency and amplitude of the oscillation of the gimbal 60.

Linear TFA Embodiments

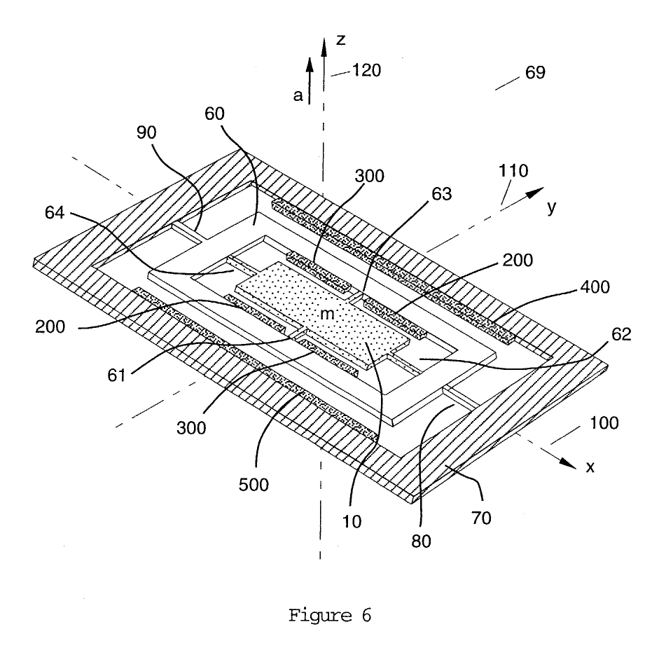

FIG. 6 depicts an embodiment of a planar, tuned flexure, linear accelerometer 69 capable of sensing acceleration input along the z-axis 120; the reference mass 10 is the inner member. The reference mass 10 is attached to the gimbal 60 by four flexures 61, 62, 63, 64 which terminate on the gimbal 60. The gimbal is mounted to the base (case) 70 by means of two flexures 80, 90. The gimbal, and with it the reference mass 10, is caused to oscillate about the x-axis 100 by an actuator 400. The motion of the gimbal is measured with pick-off 500. The said oscillatory motion induces on the reference mass 10 a negative elastic restraint for translation of the reference mass along the z-axis 120 that adds (algebraically) to the positive elastic restraint of the reference mass flexures 61, 62, 63, 64 for translation of the reference mass along the z-axis 120. Consequently, the net elastic restraint of the reference mass 10 for translation along the z-axis 120 is smaller than the elastic restraint of the flexures 61, 62, 63, 64 for those translations. Under acceleration a_{z} along the z-axis 120 the reference mass tends to translate along the z-axis 120 away from its reference position. The resulting translation of the pendulum is sensed by a pick-off 200, the pick-off signal is suitably amplified by control loop amplifier (not shown) and fed back to an actuator 300 which produces a force acting on the reference mass 10 to return it to the reference position. If desired, the net elastic restraint of the reference mass 10 for translation of the reference mass along the z-axis 120 can be made identically zero by appropriately choosing the frequency and amplitude of the oscillation of the gimbal 60.

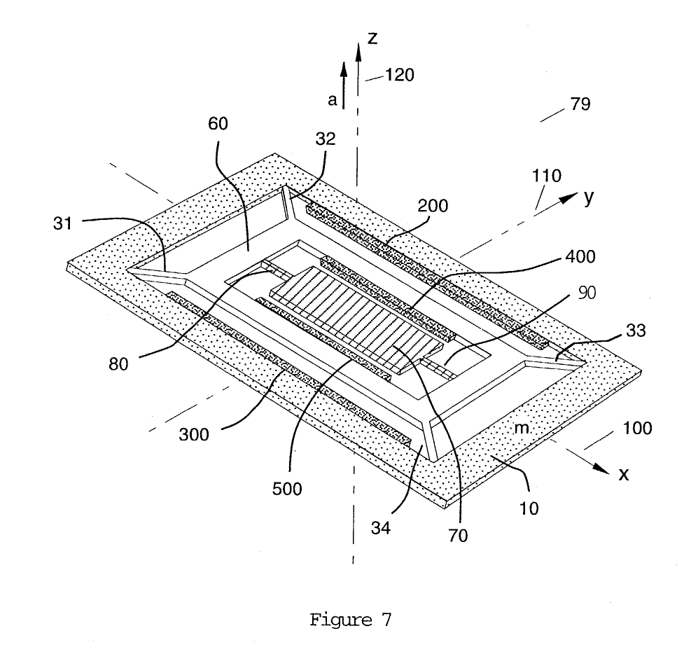

FIG. 7 depicts an embodiment of a planar, tuned flexure, linear accelerometer 79 capable of sensing acceleration input along the z-axis 120; the reference mass 10 is the outer member. The reference mass 10 is attached to the gimbal 60 by four flexures 31, 32, 33, 34 which terminate on the gimbal. The gimbal is mounted to the base (case) 70 by means of two flexures 80, 90. The gimbal, and with it the reference mass 10, is caused to oscillate about the x-axis 100 by an actuator 400. The motion is measured with pick-off 500. The said oscillatory motion induces on the reference mass 10 a negative elastic restraint for translation of the reference mass along the z-axis 120 that adds (algebraically) to the positive elastic restraint of the reference mass flexures 31, 32, 33, 34 for translation of the reference mass along the z-axis 120. Consequently, the net elastic restraint of the reference mass 10 for translation along the z-axis 120 is smaller than the elastic restraint of the flexures 31, 32, 33, 34 for those translations. Under acceleration a_{z} along the z-axis 120 the reference mass tends to translate along the z-axis 120 away from its reference position. The resulting translation of the pendulum is sensed by a pick-off 200, the pick-off signal is suitably amplified by control loop amplifier (not shown) and fed back to an actuator 300 which produces a force acting on the reference mass 10 to return it to the reference position. If desired, the net elastic restraint of the reference mass 10 for translation of the reference mass along the z-axis 120 can be made identically zero by appropriately choosing the frequency and amplitude of the oscillation of the gimbal 60.

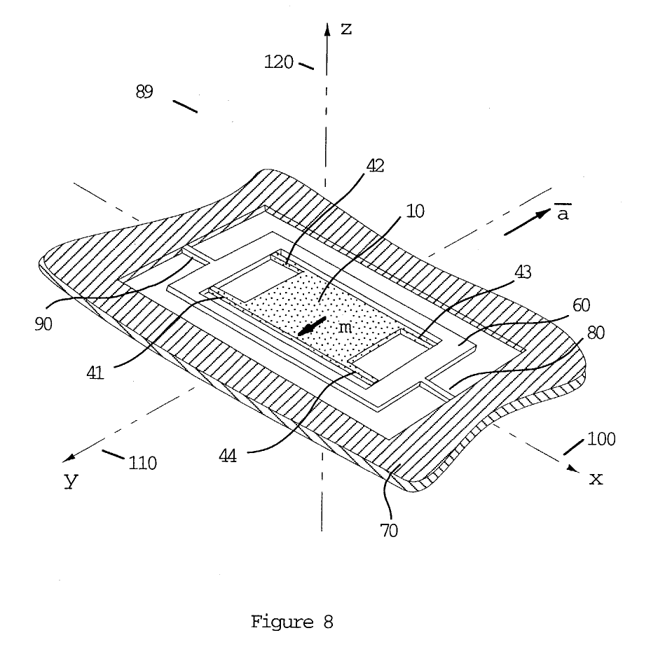

FIG. 8 depicts an embodiment of a planar, tuned flexure linear accelerometer 89 capable of sensing acceleration input along the y-axis 110; the reference mass 10 is the inner member. The reference mass 10 is attached to the gimbal 60 by four flexures 41, 42, 43, 44 which terminate on the gimbal 60. The gimbal 60 is mounted to the base (case) 70 by means of two flexures 80, 90. The gimbal, and with it the reference mass 10, is caused to oscillate about the x-axis 100 by an actuator (not shown). The said oscillatory motion induces on the reference mass 10 a negative elastic restraint for translation of the reference mass along the y-axis 110 that adds (algebraically) to the positive elastic restraint of the reference mass flexures 41, 42, 43, 44 for translation of the reference mass along the y-axis 110. Consequently, the net elastic restraint of the reference mass 10 for translation along the y-axis 110 is smaller than the elastic restraint of the flexures 41, 42, 43, 44 for those translations. Under acceleration a_{y} along the y-axis 110, the reference mass tends to translate along the y-axis 110 away from its reference position. The resulting translation of the reference mass is sensed by a pick-off (not shown), the pick-off signal is suitably amplified by control loop amplifier (not shown) and fed back to an actuator (not shown) which produces a force acting on the reference mass 10 to return it to the reference position. If desired, the net elastic restraint of the reference mass 10 for translation of the reference mass along the y-axis 110 can be made identically zero by appropriately choosing the frequency and amplitude of the oscillation of the gimbal 60.

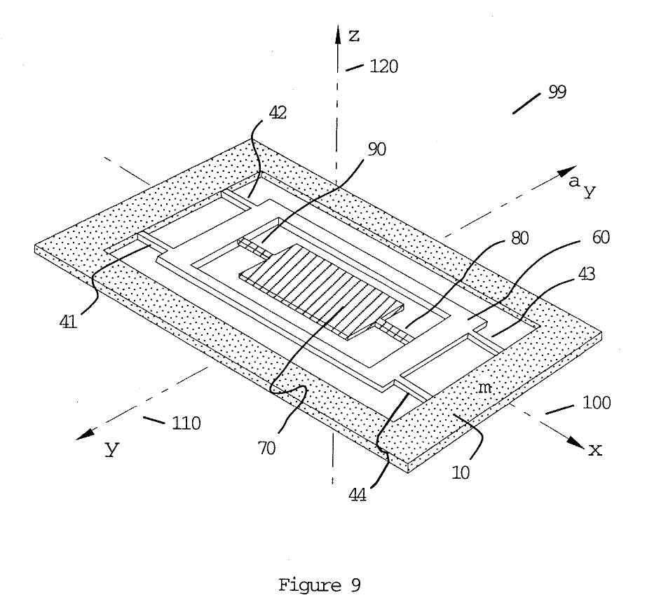

FIG. 9 depicts an embodiment of a planar, tuned flexure, linear accelerometer 99 capable of sensing acceleration input along the y-axis 110; the reference mass 10 is the outer member. The reference mass 10 is attached to the gimbal 60 by four flexures 41, 42, 43, 44 which terminate on the gimbal 60. The gimbal is mounted to the base (case) 70 by means of two flexures 80, 90. The gimbal, and with it the reference mass 10, is caused to oscillate about the x-axis 100 by an actuator (not shown). The said oscillatory motion induces on the reference mass 10 a negative elastic restraint for translation of the reference mass along the y-axis 110 that adds (algebraically) to the positive elastic restraint of the reference mass flexures 41, 42, 43, 44 for translation of the reference mass along the y-axis 110. Consequently, the net elastic restraint of the reference mass 10 for translation along the y-axis 110 is smaller than the elastic restraint of the flexures 41, 42, 43, 44 for those translations. Under acceleration a_{y} along the y-axis 110 the reference mass tends to translate along the y-axis 110 away from its reference position. The resulting translation of the reference mass is sensed by a pick-off (not shown), the pick-off signal is suitably amplified by control loop amplifier (not shown) and fed back to an actuator (not shown) which produces a force acting on the reference mass 10 to return it to the reference position. If desired, the net elastic restraint of the reference mass 10 for translation of the reference mass along the y-axis 110 can be made identically zero by appropriately choosing the frequency and amplitude of the oscillation of the gimbal 60.

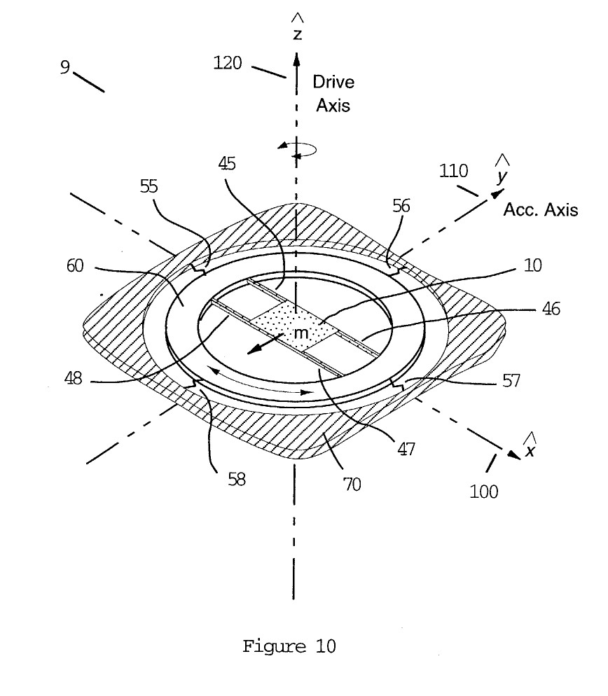

FIG. 10 depicts an embodiment of a planar, tuned flexure linear accelerometer 9 capable of sensing acceleration input along the y-axis 110; the reference mass 10 is the inner member. The reference mass 10 is attached to the gimbal 60 by flexures 45, 46, 47, 48 which terminate on the gimbal 60. The gimbal is mounted to the base (case) 70 by means of radial flexures 55, 56, 57, 58. The gimbal, and with it the reference mass 10, is caused to oscillate about the z-axis 120 by an actuator (not shown). The said oscillatory motion induces on the reference mass 10 a negative elastic restraint for translation of the reference mass along the y-axis 110 that adds (algebraically) to the positive elastic restraint of the reference mass flexures 45, 46, 47, 48 for translation of the reference mass along the y-axis 110. Consequently, the net elastic restraint of the reference mass 10 for translation along the y-axis 110 is smaller than the elastic restraint of the flexures 45, 46, 47, 48 for those translations. Under acceleration a_{y} along the y-axis 110 the reference mass tends to translate along the y-axis 110 away from its reference position. The resulting translation of the reference mass is sensed by a pick-off (not shown), the pick-off signal is suitably amplified by control loop amplifier (not shown) and fed back to an actuator (not shown) which produces a force acting on the reference mass 10 to return it to the reference position. If desired, the net elastic restraint of the reference mass 10 for translation of the reference mass along the y-axis 110 can be made identically zero by appropriately choosing the frequency and amplitude of the oscillation of the gimbal 60.

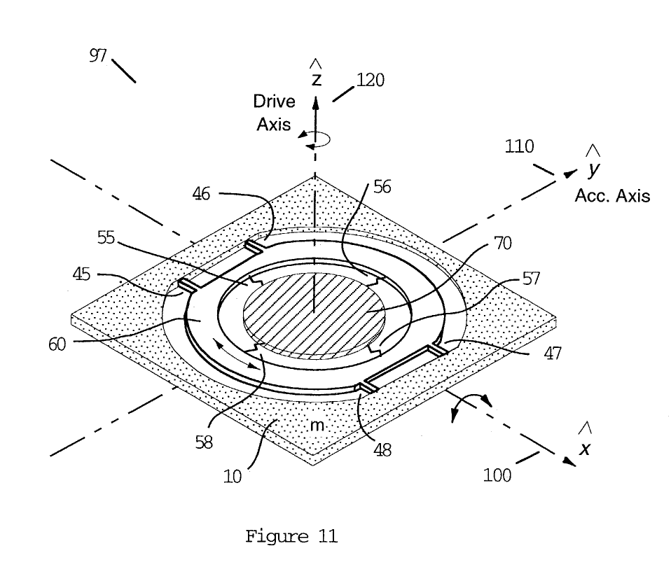

FIG. 11 depicts an embodiment of a planar, tuned flexure, linear accelerometer 97 capable of sensing acceleration input along the y-axis 110; the reference mass 10 is the outer member. The reference mass 10 is attached to the gimbal 60 by four flexures 45, 46, 47, 48 which terminate on the gimbal 60. The gimbal is mounted to the base (case) 70 by means of radial flexures 55, 56, 57, 58. The gimbal, and with it the reference mass 10, is caused to oscillate about the z-axis 120 by an actuator (not shown). The said oscillatory motion induces on the reference mass 10 a negative elastic restraint for translation of the reference mass along the y-axis 110 that adds (algebraically) to the positive elastic restraint of the reference mass flexures 45, 46, 47, 48 for translation of the reference mass along the y-axis 110. Consequently, the net elastic restraint of the reference mass 10 for translation along the y-axis 110 is smaller than the elastic restraint of the flexures 45, 46, 47, 48 for those translations. Under acceleration a_{y} along the y-axis 110 the reference mass tends to translate along the y-axis 110 away from its reference position. The resulting translation of the reference mass is sensed by a pick-off (not shown), the pick-off signal is suitably amplified by control loop amplifier (not shown) and fed back to an actuator (not shown) which produces a force acting on the reference mass 10 to return it to the reference position. If desired, the net elastic restraint of the reference mass 10 for translation of the reference mass along the y-axis 110 can be made identically zero by appropriately choosing the frequency and amplitude of the oscillation of the gimbal 60.

Pendulum, Two Degree-of-Freedom, TFA

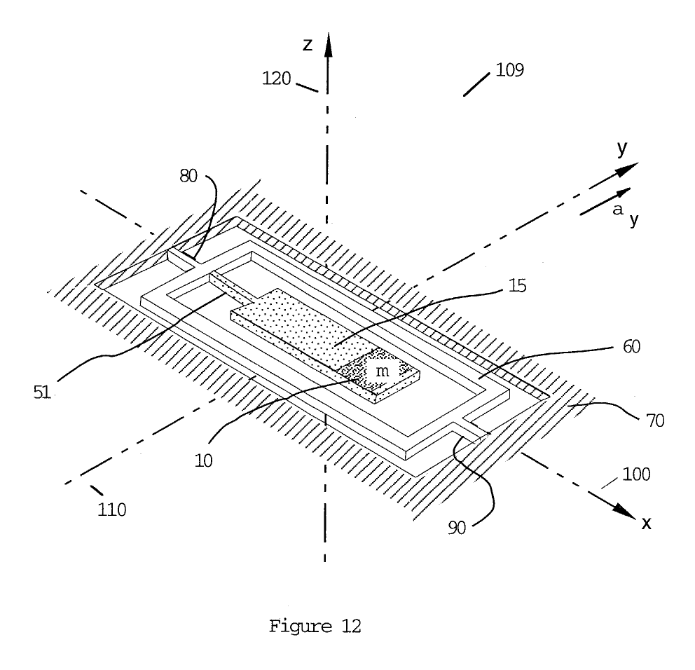

FIG. 12 depicts an embodiment of a planar, two degree-of-freedom, tuned flexure pendulous accelerometer 109 that is capable of measuring acceleration independently along two orthogonal axes. The reference mass 10 and the inner member 15 form the pendulum and the pendulum is attached to the gimbal 60 by one flexure 51 which terminates on the gimbal 60. The gimbal 60 is mounted to the base (case) 70 by means of two flexures 80, 90. The gimbal 60, and with it the pendulum, is caused to oscillate about the x-axis 100 by an actuator (not shown). The said oscillatory motion induces on the pendulum a negative elastic restraint for rotation of the pendulum about the y-axis 110 and z-axis 120 that adds (algebraically) to the positive elastic restraint of the pendulum flexure 51 for rotation of the pendulum about the y-axis 110 and z-axis 120. Consequently, the net elastic restraint of the pendulum for rotations about the y-axis 110 and z-axis 120 is smaller than the elastic restraint of the flexure 51 for those motions. Under accelerations a_{z}, a_{y} along the z-axis 120 and y-axis 110, the pendulum tends to rotate about the y-axis 110 and about the z-axis 120, respectively, away from its reference position. The resulting rotation angles of the pendulum is sensed by pick-offs (not shown), the pick-off signals are suitably amplified by control loop amplifiers (not shown) and fed back to actuators (not shown) which produce torques acting on the pendulum 10,15 to return it to the reference position. If desired, the net elastic restraint of the pendulum for rotations of the pendulum about the y-axis 110 and z-axis 120 can be made identically zero by appropriately choosing the frequency and amplitude of the oscillation of the gimbal 60, provided that the elastic restraints of the supporting flexure is the same for rotations of the pendulum about both the y-axis 110 and z-axis 120.

A one degree of freedom embodiment for measuring acceleration along the y-axis or along the z-axis can be realized by making the flexural stiffness for the rotation about one output axis much larger than the other.

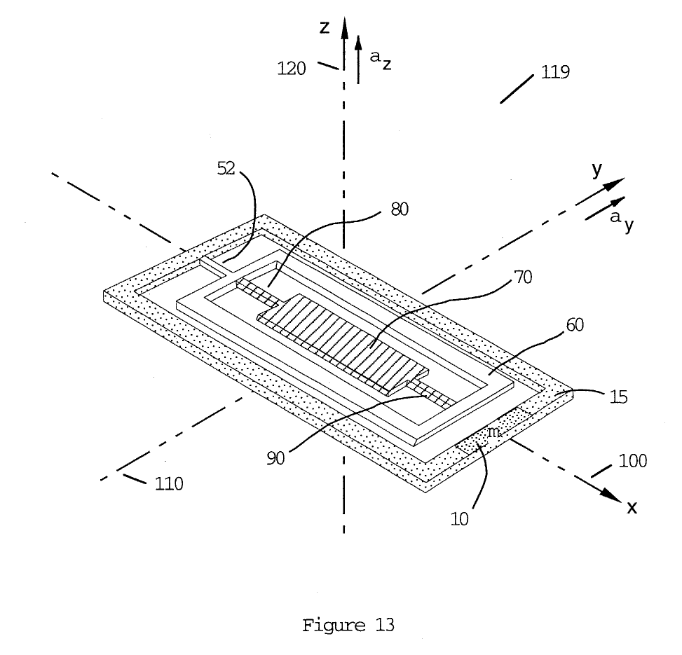

FIG. 13 depicts an embodiment of a planar, two degree-of-freedom, tuned flexure, pendulous accelerometer 119 that is capable of measuring acceleration independently along two orthogonal axes. The reference mass 10 and the outer member 15 form the pendulum and the pendulum is attached to the gimbal 60 by one flexure 52 which terminates on the gimbal 60. The gimbal 60 is mounted to the base (case) 70 by means of two flexures 80, 90. The gimbal 60, and with it the pendulum, is caused to oscillate about the x-axis 100 by an actuator (not shown). The said oscillatory motion induces on the pendulum a negative elastic restraint for rotations of the pendulum about the y-axis 110 and z-axis 120 that adds (algebraically) to the positive elastic restraint of the pendulum flexure 52 for rotations of the pendulum about the y-axis 110 and z-axis 120. Consequently, the net elastic restraint of the pendulum for rotations about the y-axis 110 and z-axis 120 is smaller than the elastic restraint of the flexure 51 for those motions. Under accelerations a_{z}, a_{y} along the z-axis 120 and y-axis 110, the pendulum tends to rotate about the y-axis 110 and about the z-axis, respectively, away from its reference position. The resulting rotation angles of the pendulum is sensed by pick-offs (not shown). The pick-off signals are suitably amplified by control loop amplifiers (not shown) and fed back to actuators (not shown) which produce torques acting on the pendulum 10,15 to return it to the reference position. If desired, the net elastic restraint of the pendulum for rotations of the pendulum about the y-axis 110 and z-axis 120 can be made identically zero by appropriately choosing the frequency and amplitude of the oscillation of the gimbal 60, provided that the elastic restraints of the supporting flexure is the same for rotations of the pendulum about both the y-axis 110 and z-axis 120.

A one degree-of-freedom embodiment for measuring acceleration along the y-axis or along the z-axis can be realized by making the flexural stiffness for the rotation about one output axis much larger than the other. The distinction of this embodiment as compared to that described in FIG. 12 is that the pendulum of this design is the outer member.

Linear, Two Degree-of-Freedom TFA

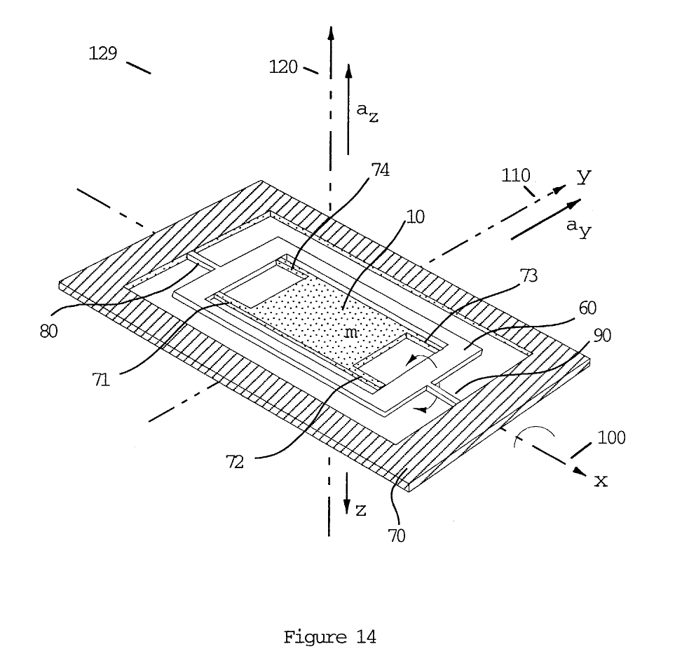

FIG. 14 depicts an embodiment of a planar, two degree-of-freedom, tuned flexure, linear accelerometer 129 that is capable of measuring acceleration independently along two orthogonal axes. The reference mass is the inner member. The reference mass 10 is attached to the gimbal 60 by four flexures 71, 72, 73, 74 which terminate on the gimbal 60. The gimbal 60 is mounted to the base 70 by means of two flexures 80, 90. The gimbal 60, and with it the reference mass, is caused to oscillate about the x-axis 100 by an actuator (not shown). The said oscillatory motion induces on the pendulum a negative elastic restraint for motions of the reference mass along the y-axis 110 and z-axis 120 that adds (algebraically) to the positive elastic restraint of the reference mass flexures 71, 72, 73, 74 for motions of the reference mass along the y-axis 110 and z-axis 120. Consequently, the net elastic restraint of the reference mass for motions along the y-axis 110 and z-axis 120 is smaller than the elastic restraint of the flexures 71, 72, 73, 74 for those motions. Under accelerations a_{z}, a_{y} along the z-axis 120 and y-axis 110, the reference mass tends to translate along the z-axis 120 and along the y-axis 110, respectively, away from its reference position. The resulting translation of the reference mass is sensed by pick-offs (not shown). The pick-off signals are suitably amplified by control loop amplifiers (not shown) and fed back to actuators (not shown) which produce forces acting on the reference mass 10 to return it to the reference position. If desired, the net elastic restraint of the reference mass for motions of the reference mass along the y-axis 110 and z-axis 120 can be made identically zero by appropriately choosing the frequency and amplitude of the oscillation of the gimbal 60, provided that the elastic restraints of the supporting flexure is the same for motions of the reference mass along both the y-axis 110 and z-axis 120 given the appropriate inertia symmetry.

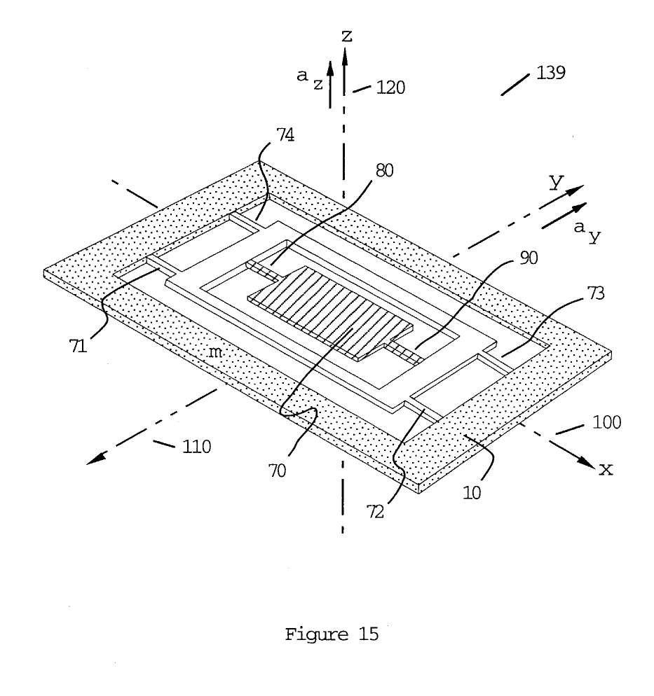

FIG. 15 depicts an embodiment of a planar, two degree-of-freedom, tuned flexure, linear accelerometer 139 that is capable of measuring acceleration independently along two orthogonal axes. The reference mass is the outer member. The reference mass 10 is attached to the gimbal 60 by four flexures 71, 72, 73, 74 which terminate on the gimbal 60. The gimbal 60 is mounted to the base 70 by means of two flexures 80, 90. The gimbal 60, and with it the reference mass, is caused to oscillate about the x-axis 100 by an actuator (not shown). The said oscillatory motion induces on the reference mass a negative elastic restraint for motions of the reference mass along the y-axis 110 and z-axis 120 that adds (algebraically) to the positive elastic restraint of the reference mass flexure 71, 72, 73, 74 for motions of the reference mass along the y-axis 110 and z-axis 120. Consequently, the net elastic restraint of the reference mass for motions along the y-axis 110 and z-axis 120 is smaller than the elastic restraint of the flexure 71, 72, 73, 74 for those motions. Under accelerations a_{z}, a_{y} along the z-axis 120 and y-axis 110, the reference mass tends to displace along the z-axis 120 and along the y-axis 110, respectively, away from its reference position. The resulting displacements of the reference mass is sensed by pick-offs (not shown), the pick-off signals are suitably amplified by control loop amplifiers (not shown) and fed back to actuators (not shown) which produce forces acting on the reference mass 10 to return it to the reference position. If desired, the net elastic restraint of the reference mass for motions of the reference mass along the y-axis 110 and z-axis 120 can be made identically zero by appropriately choosing the frequency and amplitude of the oscillation of the gimbal 60, provided that the elastic restraints of the supporting flexure is the same for motions of the reference mass along both the y-axis 110 and z-axis 120 given the appropriate inertia symmetry.

Note on Flexures

In order to describe the embodiments as specifically drawn, a number of flexures was given between any two members and a conceptual placement of the flexures was indicated. However, the number and actual design of the flexures can change according to what is required.

Multi-Layer Accelerometer Embodiment

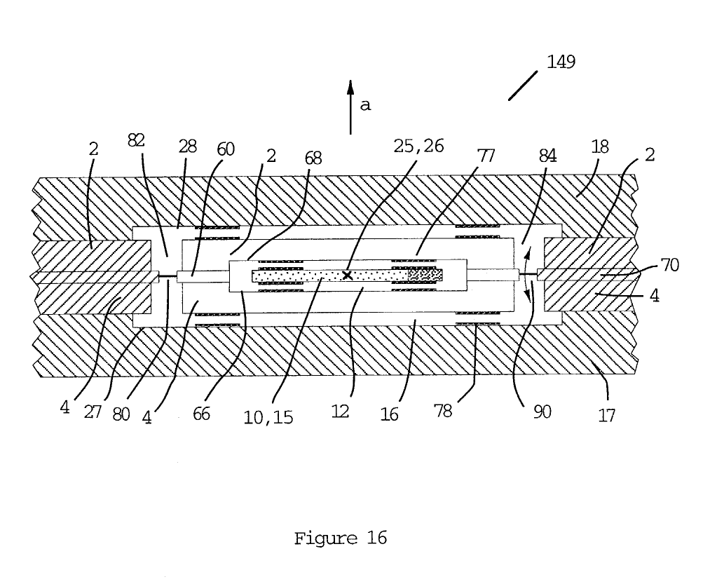

Multi-layer embodiments enable the formation of an enclosed, separate chamber for the pendulum or proof mass so that its motion can be damped. FIG. 16 is a side-view, cross-section of a conceptual multi-layer accelerometer 149 with two chambers. With this construction, the damping of the reference mass can be made higher than the damping of the gimbal oscillation. Low damping of the gimbal oscillation is important to reduce the torque required to develop the oscillation amplitude required for the desired tuning. For the same reason, it is often useful to operate the gimbal at its mechanical resonance. This construction applies to all embodiments of the tuned flexure accelerometer. In this case a pendulum described in FIG. 2 is shown.

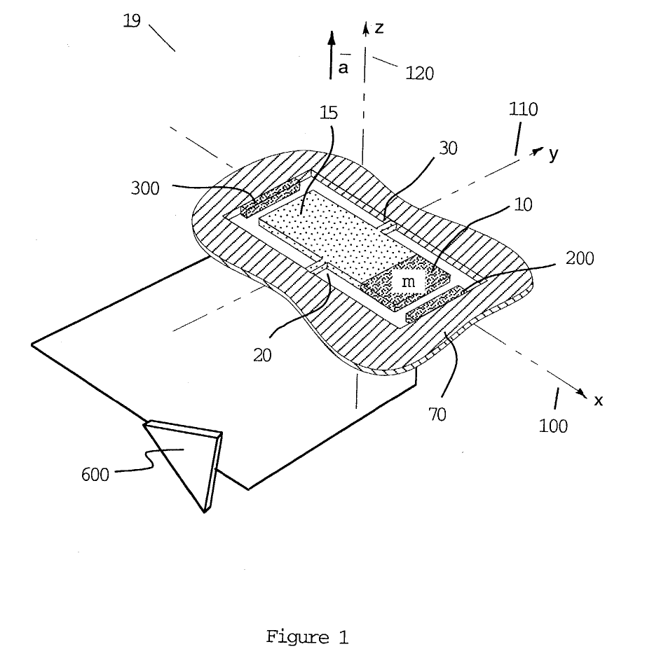

The first layer is the center layer and it contains the pendulum 10, 15 that is flexured to the gimbal 60 by flexures 25, 26. The gimbal is flexured to the case 70 by flexures 80, 90. The center layer is the planar embodiment described by FIGS. 1-15. Cover layers 2, 4 are attached by bonding on either side of the case 70 of the center layer and gimbal 60 so that the case and gimbal are sandwiched by the layers. Prior to bonding, the layers are pre-etched with wells 66, 68 on the sides facing the pendulum to form a cavity 12 within which the pendulum can rotate. The cavity pressure can be set prior to bonding to provide the damping needed. Cuts 82, 84 are etched in the two cover layers 2, 4 to enable the gimbal to be oscillated. The gimbal becomes larger by the addition of layers. Two additional layers 17, 18 are bonded to the stationary parts of layers 2, 4. Before bonding, wells 27, 28 are etched to allow motion of the larger gimbal. The wells form cavity 16 which can be evacuated to reduce air damping. Metallizations 77,78 allow the actuation and sensing of the pendulum and the gimbal, respectively.

Although specific features of the invention are shown in some drawings and not others, this is not a limitation of the invention.

What is claimed is:

1. A planar tuned flexure accelerometer that is sensitive to accelerations in the plane of the accelerometer, comprising:
a housing;
a planar gimbal coupled to the housing for oscillation about a gimbal oscillation axis;
a mass coupled by one or more flexures to the gimbal to allow motion of the mass relative to the gimbal, the one or more flexures having an effective elastic restraint; and
means for oscillating the gimbal about the gimbal oscillation axis, to create a negative elastic restraint which reduces the effective elastic restraint of the one or more flexures.

2. The planar tuned flexure accelerometer of claim 1, further comprising means for varying the gimbal oscillation amplitude to alter the elastic restraint.

3. The tuned flexure accelerometer of claim 1, further comprising means for varying the gimbal oscillation frequency to alter the elastic restraint.

4. The planar tuned flexure accelerometer of claim 1, further comprising means for varying the gimbal oscillation inertia to alter the elastic restraint.

5. The tuned flexure accelerometer of claim 1, in which the mass is coupled to the gimbal by a pair of flexures.

6. The tuned flexure accelerometer of claim 1, in which the gimbal oscillation axis is nominally orthogonal to the axis of motion of the mass.

7. The tuned flexure accelerometer of claim 1, in which the mass is carried within the gimbal.

8. The tuned flexure accelerometer of claim 1, in which the gimbal is carried within the mass.

9. The tuned flexure accelerometer of claim 1, in which the mass comprises a generally planar structure which is nominally coplanar with the gimbal.

10. The tuned flexure accelerometer of claim 1, further comprising means for sensing movement of the mass from the null position due to acceleration.

11. The tuned flexure accelerometer of claim 10, further comprising means, responsive to the means for sensing, for driving the mass closer to its null position.

12. The tuned flexure accelerometer of claim 1, in which the gimbal envelopes the mass to form a cavity in which the mass moves, to provide for damping of the mass motion by fluid located within such cavity.

13. The tuned flexure accelerometer of claim 12, in which the case envelopes the gimbal to form a cavity in which the gimbal oscillates, to allow any damping of the mass to be decoupled from any damping of the gimbal.

14. The tuned flexure accelerometer of claim 1, in which the mass is a reference mass, and the flexures allow translation of the mass relative to the case in response to accelerations.

15. The tuned flexure accelerometer of claim 1, in which the mass is a pendulous mass, and the flexures are pivots, to allow pivoting motion of the pendulous mass about a pivot axis in response to accelerations.

16. The tuned flexure accelerometer of claim 2, in which the means for varying the oscillation includes means for varying the oscillation over time, to vary the elastic restraint over time, in order to account for varying motion conditions.
